(19) United States
(12) Patent Application Publication
(10) Pub. No.: US 2024/0269642 A1
(43) Pub. Date: Aug. 15, 2024

(54) APPARATUS FOR CARRYING OUT PHOTOCHEMICAL REACTIONS

(71) Applicant: BASF SE, Ludwigshafen am Rhein (DE)

(72) Inventors: Sorin PULBERE, Ludwigshafen am Rhein (DE); Bernd SCHAEFER, Ludwigshafen am Rhein (DE); Niklas BISCH, Loerzweiler (DE); Till Christian BRÜGGEMANN, Ludwigshafen am Rhein (DE); Florian BUCHBENDER, Ludwigshafen am Rhein (DE); Steffen TSCHIRSCHWITZ, Ludwigshafen am Rhein (DE)

(21) Appl. No.: 18/293,797

(22) PCT Filed: Jul. 25, 2022
(86) PCT No.: PCT/EP2022/070722

§ 371 Date: Jan. 31, 2024

(30) Foreign Application Priority Data
Aug. 2, 2021 (EP) 21189094.2

(51) Int. Cl. B01J 19/12

(52) U.S. Cl. CPC B01J 19/127; B01J 2219/1943

(57) ABSTRACT

The invention relates to a lighting device for a photoreactor comprising a tubular housing (40) having a longitudinal axis (41) and a plurality of individual light sources (30) mounted on the inner surface of the housing (40), wherein the housing (40) comprises flow channels (46) for a heat transfer fluid, the flow channels (46) being arranged at the back side of the inner surface of the housing (40) behind the individual light sources forming a conformal cooling passage for the individual light sources. The invention further relates to a photoreactor comprising a lighting device and a reaction chamber with at least one tubular flow channel, the reaction chamber being arranged inside the lighting device and the channel wall being made of a material transmissive to the light emitted by the light sources.

The invention relates to a lighting device for a photoreactor comprising a tubular housing having a longitudinal axis and a plurality of individual light sources mounted on the inner surface of the housing. The invention further relates to a photoreactor comprising a lighting device and a reaction chamber with at least one tubular flow channel, the reaction chamber being arranged inside the lighting device and the channel wall being made of a material transmissive to the light emitted by the light sources.

Photoreactors are reactors that permit conducting photoreactions, e.g. photocatalytic reactions or photo-initiated reactions, and are well-known in the art. They are used for various kinds of reactions like bio-reactions, chemical synthesis reactions or water treatment.

The most common light source to date for photochemical conversions on an industrial scale is the medium-pressure mercury lamp, which is built for a wide range of applications from 150 W laboratory lamps to 60 kW burners. The tubes for industrial applications typically have a diameter of 5 cm and generate enormous amounts of light in a small space, i.e. the light density is very high.

Basically, these lamps have the emission spectrum of mercury, which is characterized by several lines in the UV and visible range. If the intensity of the light in the visible range is to be increased, it is possible to dope these lamps with thallium iodide, for example. Usually, medium-pressure mercury lamps are tubular structures which are operated either immersed in a stirred reactor as a submersible lamp or in a reactor in the pumping circuit, in which the reaction medium is continuously pumped past the lamp. The medium-pressure mercury lamp emits light uniformly over a large part of the lamp body. The intensity of the light from a lamp can only be controlled to a very limited extent by the power supply. A major disadvantage of mercury lamps is their comparatively low luminous efficacy of 5% to 20% in relation to the electrical power consumed. A further disadvantage is the short service life of the lamps, which in many cases is only around one year. Another major disadvantage is the use of the toxic heavy metal mercury, which has to be recovered from the tubes after their service life.

For some years now, high-intensity light-emitting diodes (“LEDs”) have been built not only for the lighting sector, but also for applications in the chemical industry, which usually produce quasi-monochromatic light in the desired range. In this case, monochromatic light means light with a full width at half maximum (FWHM) of +/−10 nm to 30 nm relative to the emission maximum. The luminous efficacy of these diodes is in the range of 10% to 60% in relation to the electrical power consumed.

The LED flow-through reactors currently on the market (e.g. the Corning photoreactor) take little account of the fact that in the case of reactions with a quantum yield of <100%, the amount of light absorbed decreases with increasing conversion. These reactors are essentially glass plates with meandering channels inside. The channels cover only about 50% to 80% of the surface of the glass plate. Each of the glass plates is irradiated evenly from both sides. Accordingly, a considerable amount of light does not enter the reaction chamber. In addition, the light produced is no longer completely absorbed as conversion increases.

Apart from the commercially available Corning photoreactor there are several other kinds of photoreactors disclosed in the literature.

Document WO 2008/145719 A1 discloses a photoreactor for bio-reactions which comprises LED plastic molded parts in which at least one LED luminous body is incorporated into a plastic matrix as a radiation source. The radiation source is arranged inside the photoreactor.

Document DE 10 2010 014 712 B3 discloses a modular photo-tubular reactor for photo-chemically treating fluidic media which comprises a central-axial irradiation unit comprising at least one radiation source, wherein the irradiation unit is coaxially surrounded by a reactor wall and encompasses an annular gap, which provides for an irradiation volume between the reactor wall and the irradiation unit.

Documents DE 10 2014 012 217 A1, DE 10 2014 012 218 A1, DE 10 2014 012 219 A1 and WO 2020/228980 A1 disclose a lamp module for inserting into photochemical reactors, the lamp module comprising a cooling body which has at least one support structure with at least one LED arranged on its outside, at least two immersion tubes that are arranged one in the other, and a head part for electrical connection of the at least one LED and for mounting the lamp module inside the photoreactor.

Document CN 209393167 U discloses reaction tube for use as a photoreactor, the reaction tube comprising an inner tube and an outer tube forming a reaction chamber between the inner and the outer tube. LED lamp beads are arranged on the inner tube facing the reaction chamber. The inner tube may be flown through by a cooling medium.

Document US 2015/0114912 A1 discloses a reactor that operates with ultraviolet light emitting diodes (UV-LEDs) to attain UV photoreactions or UV photo-initiated reaction in a fluid flow for various applications, including water purification. The UV-LED reactor is comprised of a conduit means for passing fluid flow, an ultraviolet light emitting diode (UV-LED), and a radiation-focusing element to focus the UV-LED radiation to the fluid in the longitudinal direction of the conduit. The UV-LED reactor may include photocatalysts or chemical oxidants, which are activated by UV emitted by UV-LEDs for photocatalytic and photo-initiated reactions.

Document WO 2019/056135 A1 discloses a fluid flow conduit comprising a body with a principal flow channel extending in a longitudinal direction, an inlet for introducing fluid into the principal flow channel, the inlet shaped so that an average velocity of fluid entering the principal flow channel from the inlet is oriented in an inlet flow direction nonparallel to the longitudinal direction and an outlet for conveying fluid out of the principal flow channel. The fluid conduit may be part of a photoreactor with at least one light source illuminating the principal flow channel in the longitudinal direction. The light source may be a visible light LED or UV-LED.

Even though the use of LEDs in the industrial sector has already resulted in a number of advantages over conventional medium-pressure mercury lamps, the known reactors still have some disadvantages. For example, the design of many reactors is complex, e.g. with regard to sealing, power supply and cooling of the immersion lamps. A uniform energy input over the reactor length or a targeted selective energy input into certain segments of the reactor is hardly possible with the known reactors. Targeted reaction control, e.g. with regard to conversion over the reactor length, is thus made more difficult.

It was an object of the invention to provide a photoreactor that allows full reaction control in view of conversion of the educts and which is easy to construct and to maintain.

This task is solved according to the invention by a lighting device for a photoreactor according to claim 1 and by a photoreactor according to claim 10. Advantageous variants of the lighting device and the photoreactor are presented in claims 2 to 9 and 11 to 13. A further subject of the invention is a process for performing a photoreaction according to claims 14 and 15.

A first subject of the invention is a lighting device for a photoreactor comprising a tubular housing having a longitudinal axis and a plurality of individual light sources mounted on the inner surface of the housing. According to the invention, the housing comprises flow channels for a heat transfer fluid, the flow channels being arranged at the back side of the inner surface of the housing behind the individual light sources forming a conformal cooling passage for the individual light sources. The provision of a conformal cooling passage at the back side of the individual light sources allows an efficient and fast cooling of the light sources. Compared to the prior art, light sources with higher energy emissions are possible, enlarging the area of potential applications for photoreactions. As a further advantage the provision of conformal channels allows for thin walls of the housing offering the possibility to realize lightweight photoreactors with small dimensions.

The individual light sources can be individually mounted to the inner surface of the housing. As an alternative, the individual light sources can be grouped on racks, and the racks are mounted to the inner surface of the housing. Combinations of mounting individual light sources and racks or groups of light sources are also possible.

According to the invention, the lighting device comprises a plurality of individual light sources. In a preferred embodiment the light sources are light emitting diodes (LEDs). The individual light sources may be any LED that is suitable to permit conducting photoreactions, e.g. photo-catalytic reactions or photo-initiated reactions. Depending on the reaction to be performed in a photoreactor comprising the lighting device, the number, size and shape of the individual light sources can be adapted appropriately. Preferably, light emitting diodes are used which emit light in the wavelength range from 250 nm to 800 nm. Most preferably, the light emitted by the LEDs is in the near-UV range (300 nm to 400 nm) or the visible range (400 nm to 800 nm).

In a preferred embodiment of the lighting device according to the invention a tubular protective shell made of a material transmissive to the light emitted by the light sources and having a longitudinal axis is arranged inside the tubular housing, the outer surface of the protective shell and the inner surface of the housing forming an annular channel. Preferably, the longitudinal axis of the protective shell is coaxial or identical to the longitudinal axis of the housing. It is an advantage of this embodiment that the light sources are shielded by the protective shell and thus decoupled from the reactor inside the tubular housing. In case of leakage or failure of the reactor potentially dangerous components, for example reactants, products or volatile components like solvents, are prevented from contacting the light sources.

It is further preferred for this embodiment that both ends of the annular channel are closed by a cover that is attached to the housing and to the protective shell in a sealing manner.

In a preferred variant of the lighting device with covers, at least one cover comprises sealable openings for power supply cables. In a preferred variant of the lighting device without covers, the tubular housing comprises sealable openings for power supply cables. These preferred variants can also be combined, for example in that a tubular housing as well as at least one cover comprise sealable openings for power supply cables. The sealable openings allow to provide electric power to the individual light sources or racks of individual light sources in an easy and safe way.

The individual light sources or racks of light sources can be mounted to the inner surface of the housing by known methods like positive locking or frictional connection, for example by bonding, screwing or riveting.

In one preferred embodiment the housing comprises passageways through the flow channels between the inner surface and the outer surface of the housing at the positions where the light sources are attached to the inner surface, the passageways being sealed against the flow channels. In this embodiment the individual light sources or racks of light sources can easily be mounted to the inner surface of the housing, for example by bolts that are inserted through the passageways. Furthermore, it was found that the walls of the passageways, which extend into the flow channels and are surrounded by a heat transfer fluid in operation, increase the heat transfer from the hot back side of the light sources to the cold heat transfer fluid.

In another preferred embodiment the housing comprises receptacles in form of blind holes in the flow channels between the inner surface and the outer surface of the housing, the receptacles being provided with a thread for fastening the individual light sources and being sealed against the flow channels. The receptacles are comparable to the passageways in the previous embodiment with the difference that they do not extend to the outside of the outer surface of the housing. In this embodiment the individual light sources or racks of light sources can easily be mounted to the inner surface of the housing, for example by bolts that are screwed into the threads of the receptacles. Furthermore, it was found that the walls of the receptacles, which extend into the flow channels and are surrounded by a heat transfer fluid in operation, increase the heat transfer from the hot back side of the light sources to the cold heat transfer fluid.

Embodiments with combinations of passageways through the flow channels and receptacles in form of blind holes in the flow channels are also possible.

In a preferred embodiment of the lighting device the housing is made from a material with a thermal conductivity of more than 8 W/(m·K), the material preferably being selected from the group consisting of nickel, nickel alloys, stainless steel, copper, copper alloys, aluminum and aluminum alloys. These preferable heat transfer properties allow an efficient heat transfer from the light sources to the heat transfer fluid flowing in the flow channels.

According to the invention the flow channels form a conformal cooling passage for the individual light sources. The term “conformal” means that the channel walls of the flow channels directed toward the light sources essentially follow the form of the inner surface of the tubular housing in the areas where the light sources are arranged. Preferably, the channel walls of the flow channels are provided in parallel to the inner surface of the tubular housing. This advantageous design ensures an essentially constant wall thickness between the light sources and the flow channels and thus a homogeneous heat transfer from the individual light sources to the heat transfer fluid.

In a preferred embodiment the conformal cooling passage comprises at least two flow channels that are oriented along the longitudinal axis with an inlet for a heat transfer fluid at one end of the passage and an outlet for the heat transfer fluid at the other end of the passage, wherein the at least two flow channels are fluidly connected. In this embodiment the cooling passage comprises at least two flow channels connected in series.

Preferably, the conforming cooling passage comprises from 2 to 100, more preferably from 6 to 50, in particular from 8 to 36 flow channels that are oriented along the longitudinal axis with an inlet for a heat transfer fluid at end of the first passage and an outlet for the heat transfer fluid at the other end of the passage, wherein each flow channel is fluidly connected to its neighboring flow channels. A series connection of flow channels has the advantage that a high total amount of heat exchange can be realized with little manufacturing efforts. In particular, only a small number of inlets and outlets for the flow channels is necessary.

In another preferred embodiment, the conformal cooling passage comprises an inlet for a heat transfer fluid at one end of the passage, an outlet for the heat transfer fluid at the other end of the passage, and at least two flow channels that are oriented along the longitudinal axis parallel to each other, each flow channel being fluidly connected to the inlet and to the outlet for the heat transfer fluid. In this embodiment the cooling passage comprises at least two flow channels connected in parallel. A parallel connection of flow channels has the advantage that the heat exchange can be realized with a small pressure drop along the flow channels. A further advantage is the possibility to provide symmetric flow channels, for example on different sides of the housing.

Combinations of flow channels connected in series and flow channels connected in parallel are also possible.

The conforming cooling passage is preferably designed to provide an efficient cooling of the individual light sources which leads to a homogeneous temperature profile in the axial and radial direction of the lighting device.

The flow channels can advantageously be used to remove heat produced by the light sources by flowing a low temperature heat transfer fluid through the flow channels. The heat transfer fluid may be selected for example from water, demineralized water, aqueous solutions of glycols, brines and thermal oils.

The tubular housing may have any form that is suitable to attach light sources thereon. Preferably, the inner surface of the tubular housing is formed as a n-polygon with n being the number of flat sections of the inner surface. Preferably, the number n is from 3 to 700, more preferably from 3 to 350, in particular from 6 to 36.

In a preferred embodiment of the lighting device at least at the positions where the individual light sources are attached, the wall thickness of the inner surface of the housing between the back side of the light sources and the inner wall of the respective cooling channel is from 0.3 to 2.5 mm, preferably from 0.7 to 1.5 mm. It has been found that a wall thickness in the preferred ranges facilitates a good heat transfer from the hot light sources to a cold heat transfer fluid while ensuring the stability of the housing.

The tubular housing may be produced by any known production process. Preferred processes to produce the tubular housing are additive manufacturing processes like Selective Laser Melting (SLM), Laser Beam Powder Bed Fusion, Electron Beam Melting, Electron Beam Powder Bed Fusion, Binder Jetting, FDM processes or FDM-like processes. These processes allow to realize rather complex geometries that can only hardly or not at all be realized by conventional production processes.

Depending on the roughness of the inner surfaces of the flow channels it is preferred that they are post-processed by a polishing method, for example by hydro-erosive grinding. This reduces the roughness and thus the probability of fouling inside the channels which would lead to a decrease of efficiency due to a lower thermal conductivity.

It is further preferred that the inner surface of the tubular housing is polished after its production. A polished surface allows a thorough connection between the surface and the light sources which enables an efficient heat transfer from the light sources via the surface of the housing through its wall to the heat exchange fluid flowing in the flow channel.

The tubular housing may be produced as one piece or in several pieces which are assembled afterwards to form a tubular housing. In a preferred embodiment the tubular housing is produced as one piece.

In another preferred embodiment, the tubular housing is produced in two shells, each forming a longitudinal section of the housing. In this case it is preferred that the tubular housing is produced in two half shells each of which encompasses an angular range of 180°. Preferably, each shell is provided with one or more flow channels without fluid connections to the other shell.

The tubular housing is preferably made from a material that has a high thermal conductivity and which can be processed by additive manufacturing technologies. Preferably, the material is selected from the group consisting of nickel, nickel alloys, stainless steel, copper, copper alloys, aluminum and aluminum alloys.

A second subject of the invention is a photoreactor comprising a lighting device according to the invention and a reaction chamber with at least one tubular flow channel with a longitudinal axis arranged inside the lighting device, forming a gap between the outer surface of the reaction chamber and the inner surface of the housing of the lighting device, the channel wall of the flow channel being made of a material transmissive to the light emitted by the light sources, wherein the individual light sources are light emitting diodes (LEDs) being arranged around the reaction chamber in a radial direction with respect to the longitudinal axis of the flow channel.

The photoreactor according to the invention thus comprises at least
(a) a lighting device with a tubular housing having a longitudinal axis and a plurality of individual light sources mounted on the inner surface of the housing, wherein the housing comprises flow channels for a heat transfer fluid, the flow channels being arranged at the back side of the inner surface of the housing behind the individual light sources forming a conformal cooling passage for the individual light sources, and
(b) a reaction chamber with at least one tubular flow channel with a longitudinal axis arranged inside the lighting device, forming a gap between the outer surface of the reaction chamber and the inner surface of the housing of the lighting device, the channel wall of the flow channel being made of a material transmissive to the light emitted by the light sources, wherein the individual light sources are light emitting diodes (LEDs) being arranged around the reaction chamber in a radial direction with respect to the longitudinal axis of the flow channel.

The arrangement of the light source around the reaction chamber and thus on its outside has the advantage that the intensity of the light emitted towards the reaction chamber can be controlled individually and more flexible than in photoreactor concepts known from the prior art. Furthermore, the heat produced by the light source can be removed in an easier, more efficient and more flexible way than in the case of a light source inside the reaction chamber.

Within the scope of the invention the term “photoreactor” means a flow reactor with at least one inlet for a reactant and at least one outlet for a product. The reactant flows through a reaction chamber where the reactant chemically reacts under the influence of light emitted onto the reactant to form the product.

According to the invention, the reaction chamber comprises at least one tubular flow channel to be flown through by the reactant and the resulting product. A tubular flow channel is to be understood as an elongated hollow channel the length of which is greater than its diameter, for example a tube or a pipe. The tubular flow channel has a longitudinal axis.

Preferably, the longitudinal axis of the housing is coaxial or identical to the longitudinal axis of the flow channel. The term “coaxially” means that the longitudinal axes of the housing and of the flow channel(s) are parallel and/or identical.

In a first embodiment of the photoreactor the reaction chamber comprises a single tubular flow channel. In that case, the tubular flow channel represents the reaction chamber. This embodiment is particularly suitable for reaction systems where the reactants are highly light absorbing. In such a case a single tubular flow operated in one pass-through may be sufficient to obtain the desired products with high conversion and yield.

In a second embodiment of the photoreactor the reaction chamber comprises a multitude of tubular flow channels being coaxially arranged in the reaction chamber and being in fluid connection with each other. In this context, the term “coaxially” means that the longitudinal axes of the tubular flow channels are parallel and/or identical. This embodiment is particularly suitable for reaction systems where the reactants are medium to low light absorbing. In such a case providing a multitude of tubular flow channels as reaction space allows to use the provided amount of light in an optimal way.

In a preferred variant of the second embodiment the tubular flow channels are connected in series, meaning that the outlet of a flow channel is connected to the inlet of another flow channel. Depending on the arrangement of the tubular flow channels in relation to each other, the connection may be realized by directly coupling the inlet and the outlet, e.g. for flow channels arranged one after the other, or by using u-shaped bends, e.g. for flow channels arranged besides each other in parallel. Combined arrangements of flow channels are also possible.

In another preferred variant of the second embodiment the tubular flow channels are connected in parallel, meaning that their inlets are connected to an inlet manifold and their outlets are connected to an outlet manifold.

In another preferred variant of the second embodiment the tubular flow channels are partly connected in series and partly connected in parallel.

In another preferred variant of the second embodiment the multitude of tubular flow channels comprises at least one inner tube being open at both ends and at least one outer tube being open at one end and closed on the opposite end, the inner tube being arranged concentrically inside the outer tube with an axial distance of one open end of the inner tube to the closed end of the outer tube.

Depending on the reaction to be performed in the photoreactor, the number, size and shape of the tubular flow channels can be adapted appropriately.

In a preferred embodiment the tubular flow channels are axial symmetric with respect to their respective longitudinal axes, meaning that for every cross section perpendicular to the longitudinal axis there is a point symmetry of the inner wall of the channel with respect to the longitudinal axis.

In a further preferred embodiment, the tubular flow channels are rotationally symmetric with respect to their respective longitudinal axes implying that the inner walls of the flow channels have a circular cross section.

The cross sections of the tubular flow channels may be constant or may vary over the length of the flow channel. In one embodiment the tubular flow channel has a conical form with the cross section widening in the direction of flow. This embodiment can be advantageously used for reactions in which the conversion of the reactant depends on the light absorption. With increasing cross section of the inner wall of the tubular flow channel the flow velocity decreases and the residence time of the reacting mixture inside the channel increases, thus compensating the lower light absorption in the product than in the reactant.

In one embodiment the cross section of the inner wall and of the outer wall of the tubular flow channel are identical, preferably circular, ellipsoid or polygonal.

In a further embodiment the cross section of the inner wall and of the outer wall of the tubular flow channel differ in shape. In a preferred variant of this embodiment the cross section of the inner wall is circular while the cross section of the outer wall is polygonal. This variant can be advantageously used to position individual light sources over the polygonal surface having the effect that the emitted light hits the surface perpendicularly and resulting in an efficient use of the light source.

The gap between the outer surface of the reaction chamber and the inner surface of the housing can advantageously be used for heat management or for safety provisions. In case of heat management, the gap can be empty or filled with an insulating substance. Preferably, the gap is flown through by a heat carrier medium being transmissive to the light emitted by the light sources, preferably by a silicone oil, water or a mixture comprising water and ethylene glycol. In case of safety provisions, the gap is filled or flown through by an inert medium, preferably nitrogen.

In one embodiment of the photoreactor the wall of the tubular flow channel is a double jacket. The annular space between the inner wall and the outer wall of the jacket can advantageously be used for heat management or for safety provisions. In case of heat management, the annular space can be empty or filled with an insulating substance. Preferably, the annular space is flown through by a heat carrier medium being transmissive to the light emitted by the light sources, preferably by a silicone oil, water or a mixture comprising water and ethylene glycol. In case of safety provisions, the annular space is filled or flown through by an inert medium, preferably nitrogen.

It is further preferred that a tubular protective shell made of a material transmissive to the light emitted by the light source and having a longitudinal axis is arranged in the gap between the outer surface of the reaction chamber and the inner surface of the housing of the lighting device, forming an annular channel between the outer surface of the reaction chamber and the protective shell. The longitudinal axis of the protective shell is preferably coaxial or identical to the longitudinal axis of the flow channel.

The annular channel between the outer surface of the reaction chamber and the protective shell can advantageously be used for heat management or for safety provisions. In case of heat management, the annular channel can be empty or filled with an insulating substance. Preferably, the annular channel is flown through by a heat carrier medium being transmissive to the light emitted by the light sources, preferably by a silicone oil, water or a mixture comprising water and ethylene glycol. In case of safety provisions, the annular channel is filled or flown through by an inert medium, preferably nitrogen.

The tubular flow channels may be equipped with internals like baffles or deflectors. According to the invention, the walls of the flow channels and, in a preferred embodiment, a protective shell are made of a material transmissive to the light emitted by the light source. The term “transmissive” means that the major part of the light emitted by the light sources passes through the material. Preferably, the material does not function as a filter in the incident wavelength range of the emitted light. More preferably the material is translucent or transparent, in particular transparent.

Preferably, the material is selected from the group of substances containing glass ceramics, quartz glass, borosilicate glass, plexiglass (acrylic glass), polycarbonate (PC), polyvinyl chloride (PVC), polystyrene (PS), cycloolefinic copolymer (COC), microcrystalline polyamide (PA), polyether, polyethylene terephthalate (PET), polyethylene 2,5-furanedicarboxylate (PEF) or a fluorine-containing polymer such as FEP. The material may also be a mixture or a composite material of at least two of the above-mentioned substances. Fluorine-containing polymers are preferred among polymers.

Plexiglas (acrylic glass) includes polymethyl methacrylate (PMMA) of different tacticity, fluorinated polymethyl methacrylate of different tacticity and polymethyl methacrylimide (PMMI) of different tacticity. Polycarbonates (PC) are thermoplastics which are formally polyesters of carbonic acid. Polyvinyl chloride (PVC) is a polymer obtained from vinyl chloride by emulsion polymerization (E-PVC), suspension polymerization (S-PVC) or mass polymerization from vinyl chloride itself (M-PVC). Polystyrene (PS) is an atactic, syndiotactic or isotactic polymer produced from styrene. Cycloolefinic copolymer (COC) is an amorphous polyolefin obtained from monomeric olefins having a cyclohexene ring and monomeric ethene. Microcrystalline polyamide (PA) is a polymer prepared from aminocarboxylic acids (AS type) or from a mixture of a dicarboxylic acid and a diamond (ASSA type) which forms crystalline domains. Polyethers are long chain, mostly aromatic ethers such as polyether ether ketone. Polyethylene terephthalate (PET) is a polymer produced from ethylene glycol and terephthalic acid. Polyethylene 2,5-furandicarboxylate (PEF) is a polymer prepared from 2,5-furandicarboxylic acid and ethylene glycol. FEP means a tetrafluoroethylene-hexafluoropropylene copolymer.

Depending on the number and arrangement of tubular flow channels the reaction chamber can have different sizes and shapes. In the case of a single tubular flow channel or multiple tubular flow channels that are concentrically arranged, the outer wall of the outermost tubular flow channel represents the outer surface of the reaction chamber. In the case of multiple tubular flow channels arranged besides each other, the outer surface of the reaction chamber is formed by segments of the outer walls of the outermost flow channels.

In a preferred embodiment of the photoreactor the outer surface of the reaction chamber comprises sections of channel walls that are flat or concave. It is an advantage of this embodiment that the coupling energy for the light emitted by the light sources is higher in areas with flat or concave sections.

In a further preferred embodiment of the photoreactor the outer surface of the reaction chamber is coated with an anti-reflective coating. The advantage of this embodiment is that the transmission of light and thus the efficiency of the photoreactor is increased.

In a further preferred embodiment of the photoreactor the outer surface of the reaction chamber comprises sections of channel walls that have indentations which are dome-shaped, cone-shaped or pyramid-shaped.

In this embodiment it is further preferred that the light source comprises a multitude of individual light sources which are assigned to the indentations emitting the light in the direction of the indentations. In this embodiment the loss of energy by reflection of the light emitted by the light sources can be minimized.

The reaction chamber can be produced by any known manufacturing technique, for example hot forming, machining or additive manufacturing.

According to the invention, the photoreactor comprises LEDs as individual light sources being arranged around the reaction chamber in a radial direction with respect to the longitudinal axis of the flow channel.

In a further preferred embodiment of the photoreactor the light sources are arranged around the reaction chamber with an axial symmetry of the light sources with respect to the longitudinal axis of the reaction chamber, meaning that for every cross section perpendicular to the longitudinal axis there is a point symmetry of the light emitting surface of the light sources with respect to the longitudinal axis.

In a preferred embodiment the cross-section of the inner surface of the tubular housing perpendicular to the longitudinal axis of the flow channel has the form of a n-polygon with n being the number of flat sections of the inner surface. Preferably, the number n is from 3 to 700, more preferably from 3 to 350, in particular from 6 to 36. The flat inner surfaces of the n-polygon are well suitable for mounting the individual light sources or racks or groups of light sources.

A third subject of the invention is a process for performing a photoreaction in a photoreactor according to the invention comprising the steps of flowing at least one reactant through the reaction chamber and irradiating the reactant by light emitted from the light sources.

In a preferred embodiment of the process for performing a photoreaction the light source comprises a multitude of individual light sources and the intensity of the light emitted by the individual light sources is adapted dependent on the conversion rate of the photoreaction along the flow channel.

It is further preferred that at least one product of the photoreaction is vitamin A.

The invention is explained in more detail below with reference to the drawings. The drawings are to be interpreted as in-principle presentation. They do not constitute any restriction of the invention, for example with regards to specific dimensions or design variants. In the figures:

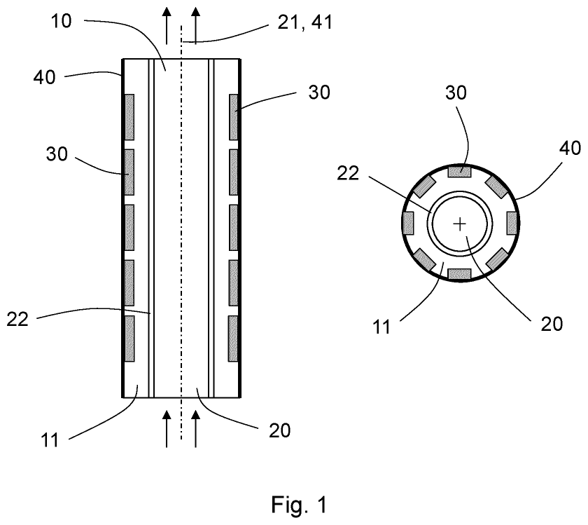

FIG. 1 shows a longitudinal cut view and a cross-sectional cut view of a photoreactor with a single flow channel as a first embodiment according to the invention.

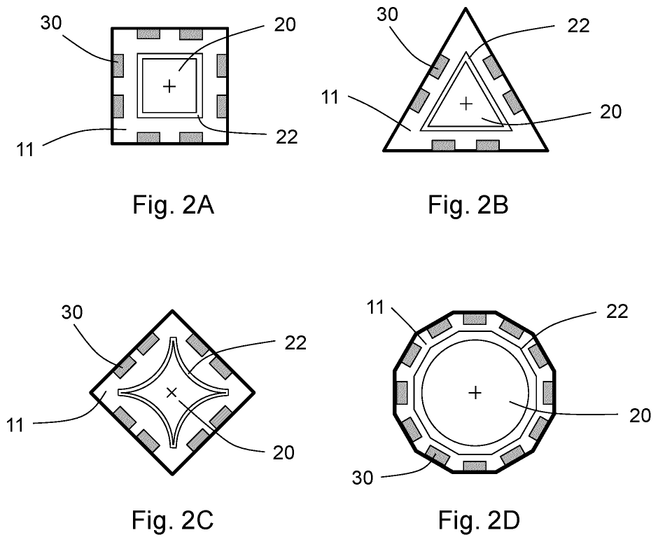

FIG. 2 shows cross-sectional cut views of four different variants of the photoreactor of FIG. 1.

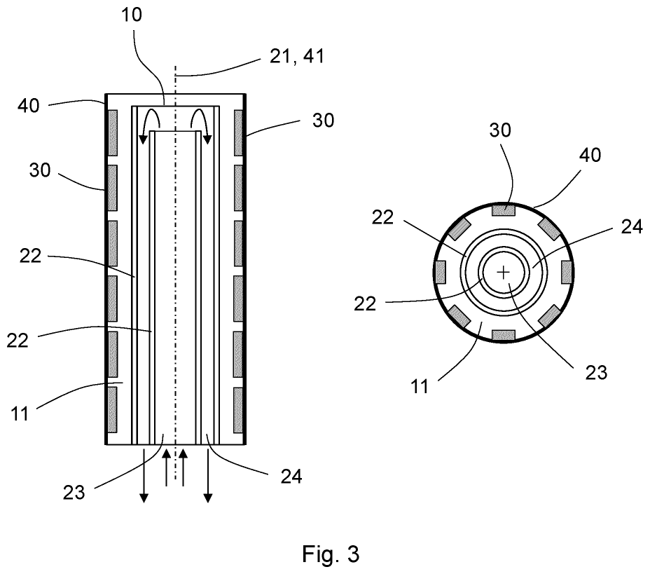

FIG. 3 shows a longitudinal cut view and a cross-sectional cut view of a photoreactor with a flow channel comprising an inner tube and an outer tube as a second embodiment according to the invention.

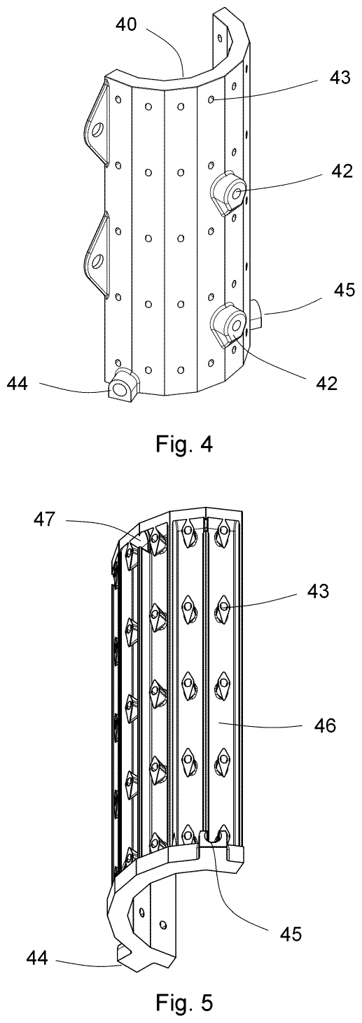

FIG. 4 shows a three-dimensional view of a shell of a tubular housing for a first embodiment of a lighting device according to the invention.

FIG. 5 shows a cut-away view of the shell of FIG. 4.

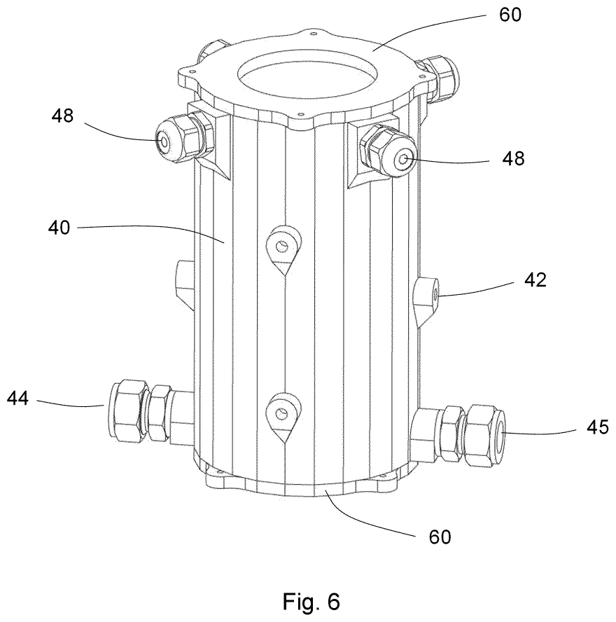

FIG. 6 shows a three-dimensional view of a second embodiment of a lighting device according to the invention.

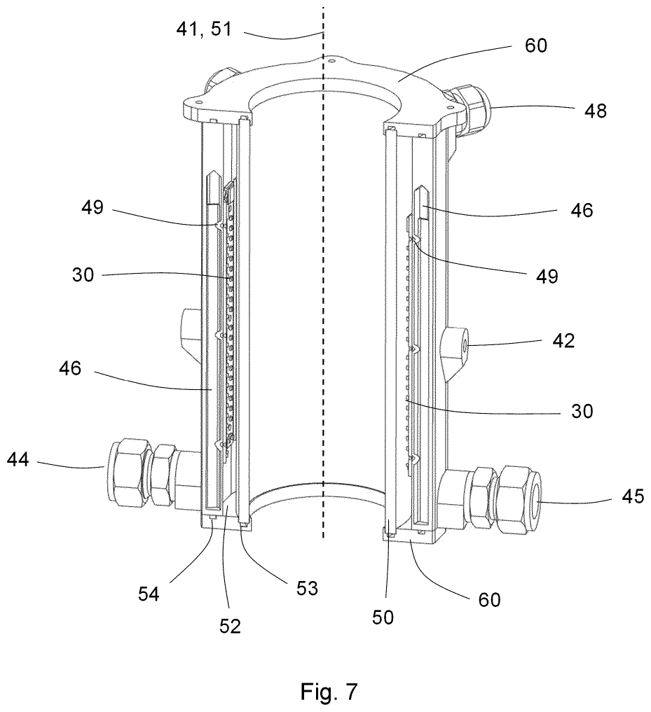

FIG. 7 shows a longitudinal cut view of the lighting device of FIG. 6.

### LIST OF REFERENCE NUMERALS USED

10 . . . reaction chamber
11 . . . annular space
20 . . . flow channel
21 . . . longitudinal axis
22 . . . wall
23 . . . inner tube
24 . . . outer tube
30 . . . light source
40 . . . housing
41 . . . longitudinal axis
42 . . . mounting element
43 . . . passageway
44 . . . inlet for heat transfer fluid
45 . . . outlet for heat transfer fluid
46 . . . flow channel
47 . . . deflection of flow channel
48 . . . opening for power supply
49 . . . receptacle
50 . . . protective shell
51 . . . longitudinal axis
52 . . . annular channel
53 . . . seal
54 . . . seal
60 . . . cover

### Example 1

FIG. 1 shows a longitudinal cut view (left) and a cross-sectional cut view (right) of a photoreactor with a single flow channel as a first embodiment according to the invention. The photoreactor comprises a lighting device and a reaction chamber 10. The lighting device comprises a tubular housing 40 having a longitudinal axis 41 and a plurality of individual light sources 30 mounted on the inner surface of the housing 40. The reaction chamber 10 comprises a tubular flow channel 20 that is flown through by a reaction mixture from the bottom to the top (arrows). The flow channel 20 is a hollow cylinder with a circular cross-section, the channel wall 22 being symmetrically aligned around a longitudinal axis 21. Thus, the inner and the outer surface of the channel wall 22 are convex from the perspective of the light sources 30. In this first embodiment the reaction chamber 10 is identical to the flow channel 20. The channel wall 22 is made of a material transmissive to the light emitted by the light sources 30. The individual light sources 30 are light emitting diodes (LEDs) and are arranged around the reaction chamber 10 in a radial direction with respect to the longitudinal axis 21 of the flow channel 20. The tubular flow channel 20 is arranged inside the lighting device, forming a gap 11 between the outer surface of the reaction chamber 10 and the inner surface of the housing 40 of the lighting device. The gap 11 can be filled with or flown through by a heat transfer fluid being transmissive to the light emitted by the light sources 30, preferably by a silicone oil. The longitudinal axis 41 of the housing 40 is identical to the longitudinal axis 21 of the flow channel 20.

FIGS. 2A to 2D show cross-sectional cut views of four different variants of the photoreactor according to FIG. 1. They differ from each other and from the variant according to FIG. 1 in the cross-section of the channel wall 22 and of the tubular housing for the LEDs as light sources 30 that surrounds the channel wall 22. In all variants the channel wall 22 and the light sources 30 are symmetric with respect to the longitudinal axis (denoted as “+” in the drawings).

In the variant of the photoreactor according to FIG. 2A the channel wall 22 and the tubular housing for the light sources 30 is square in cross-section. The LEDs are arranged on the inner surfaces of the tubular housing in a way that their light is perpendicularly emitted onto the planar outer surface of the channel wall 22. The inner surface of the channel wall 22 is planar, too.

In the variant of the photoreactor according to FIG. 2B the channel wall 22 and the tubular housing for the light sources 30 is triangular in cross-section. The LEDs are arranged on the inner surfaces of the tubular housing in a way that their light is perpendicularly emitted onto the planar outer surface of the channel wall 22. The inner surface of the channel wall 22 is planar, too.

In the variant of the photoreactor according to FIG. 2C the reaction chamber is formed by four segments of the channel wall 22 that are inwardly curved and are connected at their edges, the edges forming a square in cross-section. The four wall segments of the channel wall 22 have concave inner and outer surfaces from the perspective of the light sources 30. The tubular housing for the light sources 30 is square in cross-section. The LEDs as light sources 30 are mounted flat to the inner walls of the tubular housing emitting their light onto the concave outer surface of the channel wall 22.

In the variant of the photoreactor according to FIG. 2D the cross-section of the outer surface of the channel wall 22 and of the tubular housing for the light sources 30 is a regular dodecagon. The LEDs are arranged on the inner surfaces of the tubular housing in a way that their light is perpendicularly emitted onto the twelve planar segments of the outer surface of the channel wall 22. The inner surface of the channel wall 22 is circular in cross-section.

### Example 2

FIG. 3 shows a longitudinal cut view (left) and a cross-sectional cut view (right) of a photoreactor with a flow channel comprising an inner tube and an outer tube as a second embodiment according to the invention. The photoreactor comprises a lighting device and a reaction chamber 10. The lighting device comprises a tubular housing 40 having a longitudinal axis 41 and a plurality of individual light sources 30 mounted on the inner surface of the housing 40.

The reaction chamber 10 comprises an inner tube 23 being open at both ends and an outer tube 24 being open at its lower end and closed on its upper end. The inner tube 23 is arranged concentrically inside the outer tube 24 with an axial distance of the upper open end of the inner tube to the upper closed end of the outer tube. The inner tube 23 and the outer tube 24 form one tubular flow channel that is flown through by a reaction mixture from the bottom to the top of the inner tube 23 and then from the top to the bottom of the outer tube 24 (arrows). The flow channel is a hollow cylinder with a circular cross-section, the channel walls 22 being symmetrically aligned around a longitudinal axis 21. Thus, the inner and the outer surface of the channel wall 22 are convex from the perspective of the light sources 30.

In this second embodiment the reaction chamber 10 is identical to the flow channel 20. The channel walls 22 are made of a material transmissive to the light emitted by the light sources 30. The individual light sources 30 are light emitting diodes (LEDs) and are arranged around the reaction chamber 10 in a radial direction with respect to the longitudinal axis 21 of the flow channel 23, 24. The tubular flow channel is arranged inside the lighting device, forming a gap 11 between the outer surface of the reaction chamber 10 and the inner surface of the housing 40 of the lighting device. The gap 11 can be filled with or flown through by a heat transfer fluid being transmissive to the light emitted by the light sources 30, preferably by a silicone oil. The longitudinal axis 41 of the housing 40 is identical to the longitudinal axis 21 of the flow channel.

### Example 3

FIG. 4 shows a three-dimensional view of a shell of a tubular housing 40 for a first embodiment of a lighting device according to the invention. FIG. 5 shows a cut-away view of the shell of FIG. 4, the outer wall of the tubular housing not being shown. In this exemplary embodiment two shells as shown in FIG. 4 are assembled to form the tubular housing 40. The shell forms a longitudinal section of the housing and encompasses an angular range of 180°. The shell comprises several flanges for assembling two of the shells to form the tubular housing. Mounting elements 42 are provided on the outside of the tubular housing 40 to be able to mount the housing to a support.

The inner surface and the outer surface of the shell is formed as a polygon with eight flat sections each. Thus, the inner surface of the assembled tubular housing is formed as a polygon with sixteen flat section of the inner surface. The tubular housing 40 is configured in such a way as to be able to attach a multitude of individual light sources (not shown in FIG. 4) to the inner surface of the housing 40. The individual light sources may be light emitting diodes (LEDs), either as individual LEDs or as racks comprising several LEDs. For this purpose, each section of the polygon comprises passageways 43 between the inner surface and the outer surface of the shell. The individual light sources or racks of light sources can easily be mounted to the inner surface of the housing, for example by bolts that are inserted through the passageways 43 and are fixed from the outside.

The tubular housing 40 is configured to be flown through by a heat transfer fluid. The housing 40 comprises flow channels 46 for a heat transfer fluid, the flow channels 46 being arranged at the back side of the inner surface of the housing 40 behind the individual light sources forming a conformal cooling passage for the individual light sources. In the example shown in FIG. 5 the conformal cooling passage comprises eight flow channels 46 that are oriented along the longitudinal axis of the housing 40, one flow channel 46 in each of the eight sections of the polygon. The flow channels 46 are separated from each other by walls that extend from the back side of the inner wall of the housing to the back side of the outer wall of the housing. Each flow channel 46 is fluidly connected to its neighboring flow channels by a cutout in the separating walls that constitute a deflection 47 of the flow channels. The cooling passage has a labyrinthine shape, extending between an inlet for a heat transfer fluid 44 at one end of the passage and an outlet for the heat transfer fluid 45 at the other end of the passage.

The passageways 43 for fixing the light sources extend through the flow channels 46 between the inner surface and the outer surface of the housing 40 at the positions where the light sources 30 are attached to the inner surface. In the example shown the passageways 43 are formed by channels that are closed in the radial direction and are thus being sealed against the flow channels 46. Apart from the sealing, it was found that this configuration of passageways has the further advantage that the walls of the passageways, which extend into the flow channels and are surrounded by the heat transfer fluid in operation, increase the heat transfer from the hot back side of the light sources to the cold heat transfer fluid.

### Example 4

FIG. 6 shows a three-dimensional view of a second embodiment of a lighting device according to the invention. FIG. 7 shows a longitudinal cut view of the lighting device of FIG. 6. The lighting device for a photoreactor comprises a tubular housing 40 having a longitudinal axis 41. In this exemplary embodiment the tubular housing 40 is fabricated in one piece. Mounting elements 42 are provided on the outside of the tubular housing 40 to be able to mount the housing to a support. LEDs grouped on longitudinal racks are mounted as individual light sources 30 on the inner surface of the housing 40.

The housing 40 comprises flow channels 46 for a heat transfer fluid, the flow channels 46 being arranged at the back side of the inner surface of the housing 40 behind the individual light sources 30 forming a conformal cooling passage for the individual light sources 30. Similar to the previous example, in the embodiment shown in FIGS. 6 and 7 the conformal cooling passage comprises several flow channels 46 that are oriented along the longitudinal axis 41 of the housing 40. The flow channels 46 are separated from each other by walls that extend from the back side of the inner wall of the housing to the back side of the outer wall of the housing. Each flow channel 46 is fluidly connected to its neighboring flow channels by a cutout in the separating walls that constitute a deflection of the flow channels. The cooling passage has a labyrinthine shape, extending between an inlet for a heat transfer fluid 44 at one end of the passage and an outlet for the heat transfer fluid 45 at the other end of the passage. In this example, the housing 40 comprises receptacles 49 in form of blind holes in the flow channels 46 between the inner surface and the outer surface of the housing 40, the receptacles 49 being provided with a thread for fastening the racks of individual light sources and being sealed against the flow channels 46.

The lighting device according to this embodiment further comprises a tubular protective shell 50 made of a material transmissive to the light emitted by the light sources 30 and having a longitudinal axis 51 that is arranged inside the tubular housing 40. The outer surface of the protective shell 50 and the inner surface of the housing 40 form an annular channel 52. The longitudinal axis 51 of the protective shell 50 is identical to the longitudinal axis 41 of the housing 40. Both ends of the annular channel 52 are closed by a cover 60 that is attached to the housing 40 and to the protective shell 50 in a sealing manner. At the upper end of the tubular housing 40 openings 48 for power supply cables are provided. These openings are sealed against the flow channels 46.

1.-15. (canceled)

16. A lighting device for a photoreactor comprising a tubular housing having a longitudinal axis and a plurality of individual light sources mounted on the inner surface of the housing, wherein the housing comprises flow channels for a heat transfer fluid, the flow channels being arranged at the back side of the inner surface of the housing behind the individual light sources forming a conformal cooling passage for the individual light sources, such that the channel walls of the flow channels directed toward the light sources essentially follow the form of the inner surface of the tubular housing in the areas where the light sources are arranged.

17. The lighting device according to claim 16, wherein the light sources are light emitting diodes (LEDs) with a wavelength from 250 nm to 800 nm.

18. The lighting device according to claim 16, wherein a tubular protective shell made of a material transmissive to the light emitted by the light sources and having a longitudinal axis is arranged inside the tubular housing, the outer surface of the protective shell and the inner surface of the housing forming an annular channel, the longitudinal axis of the protective shell being preferably coaxial or identical to the longitudinal axis of the housing.

19. The lighting device according to claim 18, wherein both ends of the annular channel are closed by a cover that is attached to the housing and to the protective shell in a sealing manner.

20. The lighting device according to claim 16, wherein the housing comprises passageways (43) through the flow channels between the inner surface and the outer surface of the housing at the positions where the light sources are attached to the inner surface, the passageways being sealed against the flow channels.

21. The lighting device according to claim 16, wherein the housing comprises receptacles in form of blind holes in the flow channels between the inner surface and the outer surface of the housing, the receptacles being provided with a thread for fastening the individual light sources and being sealed against the flow channels.

22. The lighting device according to claim 16, wherein the housing is made from a material with a thermal conductivity of more than 8 W/(m·K).

23. The lighting device according to claim 16, wherein the conformal cooling passage comprises at least two flow channels that are oriented along the longitudinal axis with an inlet for a heat transfer fluid at one end of the passage and an outlet for the heat transfer fluid at the other end of the passage, wherein the at least two flow channels are fluidly connected.

24. The lighting device according to claim 16, wherein the conformal cooling passage comprises an inlet for a heat transfer fluid at one end of the passage, an outlet for the heat transfer fluid at the other end of the passage, and at least two flow channels that are oriented along the longitudinal axis parallel to each other, each flow channel being fluidly connected to the inlet and to the outlet for the heat transfer fluid.

25. A photoreactor comprising a lighting device according to claim 16 and a reaction chamber with at least one tubular flow channel with a longitudinal axis arranged inside the lighting device, forming a gap between the outer surface of the reaction chamber and the inner surface of the housing of the lighting device, the channel wall of the flow channel being made of a material transmissive to the light emitted by the light sources, wherein the individual light sources are light emitting diodes being arranged around the reaction chamber in a radial direction with respect to the longitudinal axis of the flow channel.

26. The photoreactor according to claim 25, wherein the longitudinal axis of the housing is coaxial or identical to the longitudinal axis of the flow channel.

27. The photoreactor according to claim 25, wherein a tubular protective shell made of a material transmissive to the light emitted by the light source and having a longitudinal axis is arranged in the gap, forming an annular channel between the outer surface of the reaction chamber and the protective shell, the longitudinal axis of the protective shell being coaxial or identical to the longitudinal axis of the flow channel.

28. The photoreactor according to claim 25, wherein the cross-section of the inner surface of the housing perpendicular to the longitudinal axis of the flow channel has the form of a n-polygon with n being the number of flat sections of the inner surface, wherein the number n is from 3 to 700.

29. A process for performing a photoreaction in a photoreactor according to claim 25 comprising the steps of flowing at least one reactant through the reaction chamber and irradiating the reactant by light emitted from the light sources.

30. The process according to claim 29, wherein at least one product of the photoreaction is vitamin A.
